(19) United States
(12) Patent Application Publication
(10) Pub. No.: US 2014/0342050 A1
(43) Pub. Date: Nov. 20, 2014

(54) Imprinted Lollipop

(71) Applicant: Gordon Washington, Baird, TX (US)

(72) Inventor: Gordon Washington, Baird, TX (US)

(21) Appl. No.: 14/271,086

(22) Filed: May 6, 2014

Related U.S. Application Data
(60) Provisional application No. 61/824,154, filed on May 16, 2013.

(51) Int. Cl. A23G 3/56; A23G 3/34; A63F 1/00

(52) U.S. Cl. CPC A23G 3/563; A63F 1/00; A23G 3/0055; A23V 2002/00
USPC 426/87; 426/383

(57) ABSTRACT

An imprinted lollipop has one or more symbols imprinted on the stick portion of the lollipop and one or more symbols imprinted on the candy portion of the lollipop. The candy portion may be covered with an opaque or partially opaque wrapping to mask the imprint on the candy portion.

### CROSS REFERENCE TO RELATED APPLICATION

This application claims the benefit of Provisional U.S. patent application Ser. No. 61/824,154 filed on May 16, 2013.

### STATEMENT REGARDING FEDERALLY FUNDED RESEARCH AND DEVELOPMENT

The invention described in this patent application was not the subject of federally sponsored research or development.

### FIELD

The present invention pertains to lollipops; more particularly, the present invention pertains to lollipops which contain printing on both the stick portion and the candy portion to enable their use as either an educational aid, to play a game or enhance their visual appeal.

### BACKGROUND

A lollipop including a stick and a piece of wrapped candy affixed to one end of the stick is well known. While numerous modifications have been made to the lollipop, including the type, flavor or composition of the candy affixed to the stick, the shape of the candy affixed to the stick, the shape of the stick, and the type of wrapping around the candy, nothing has been done to transform the lollipop into an educational aid, to transform the lollipop into something which enables the playing of a game, such as the many variations of the card game poker, along with enhancing the visual appeal of the lollipop.

### SUMMARY

In the preferred embodiment, the present invention transforms the lollipop into an educational aid or something which enables the playing of a card game such as poker. The imprinted lollipop of the present invention includes a wrapped piece of candy affixed to a stick. Both the wrapped piece of candy and the stick are imprinted with symbols or information imprinted on the piece of candy. In one embodiment of the invention, all or a portion of the wrapping on the candy is opaque so that whatever is imprinted on the candy cannot be seen until the wrapper is removed.

When the lollipop is used for teaching a game using the symbols from a standard deck of playing cards, such as poker, the opaque portion of the wrapper covering the piece of candy masks a set of symbols related to the set of symbols on the lollipop stick. When the opaque cover is removed, the set of cards represented by the symbols on the stick is put together with the symbol on the piece of candy to determine the ranking of the combination of the set of symbols in a card game such as poker.

### BRIEF DESCRIPTION OF THE DRAWING FIGURES

A still better understanding of the imprinted lollipop of the present invention may be had by reference to the drawing figures wherein:

FIG. 1 is a top plan view of the imprinted lollipop according to the present invention showing a set of symbols representing four playing cards imprinted on the stick, and a cover having an opaque portion placed over the imprint on the candy piece mounted on one end of the lollipop stick;

FIG. 2 is a top plan view of the imprinted lollipop as shown in FIG. 1 wherein the front side of the cover having an opaque portion placed over the imprinted candy mounted on one end of the lollipop stick has been removed, thereby revealing a playing card symbol imprinted on the candy, which playing card symbol is combined with the playing card symbol on the lollipop stick;

FIG. 3A and FIG. 3B are top plan views of two imprinted lollipops as shown in FIG. 2 wherein holders of the imprinted lollipops as shown in FIG. 3A and in FIG. 3B, can compare the sets of information appearing on the imprinted lollipops, after the covers have been removed, to determine which player has the highest ranking combination of playing card symbols according to the rules of poker;

FIG. 4A is a top plan view of another embodiment of the printed lollipop according to the present invention showing a citation from the Holy Bible and a cover having an opaque portion placed over the imprinted candy piece mounted on one end of the lollipop stick;

FIG. 4B is a top plan view of the embodiment of the imprinted lollipop shown in FIG. 4A but with the cover having an opaque portion removed to reveal the verse from the Holy Bible related to the citation imprinted on the lollipop stick;

FIG. 5A is a top plan view of the imprinted lollipop as shown in FIG. 1 showing information printed on the lollipop stick and a clear cover over the candy affixed to one end of the lollipop stick;

FIG. 5B is a bottom plan view of the other side of the imprinted lollipop as shown in FIG. 6 wherein the pronunciation of the term imprinted on one side of the lollipop stick appears on the other side of the lollipop stick;

FIG. 6 is a top plan view of the imprinted lollipop as shown in FIG. 5A and in FIG. 5B including information imprinted on the lollipop stick, and a translucent cover over the related image on the imprinted candy affixed to one end of the lollipop stick; and

FIG. 7 is a top plan view of the imprinted lollipop as shown in FIG. 1 including information imprinted on the lollipop stick, and a clear cover over the image on the imprinted candy affixed to one end of the lollipop stick.

### DESCRIPTION OF THE EMBODIMENTS

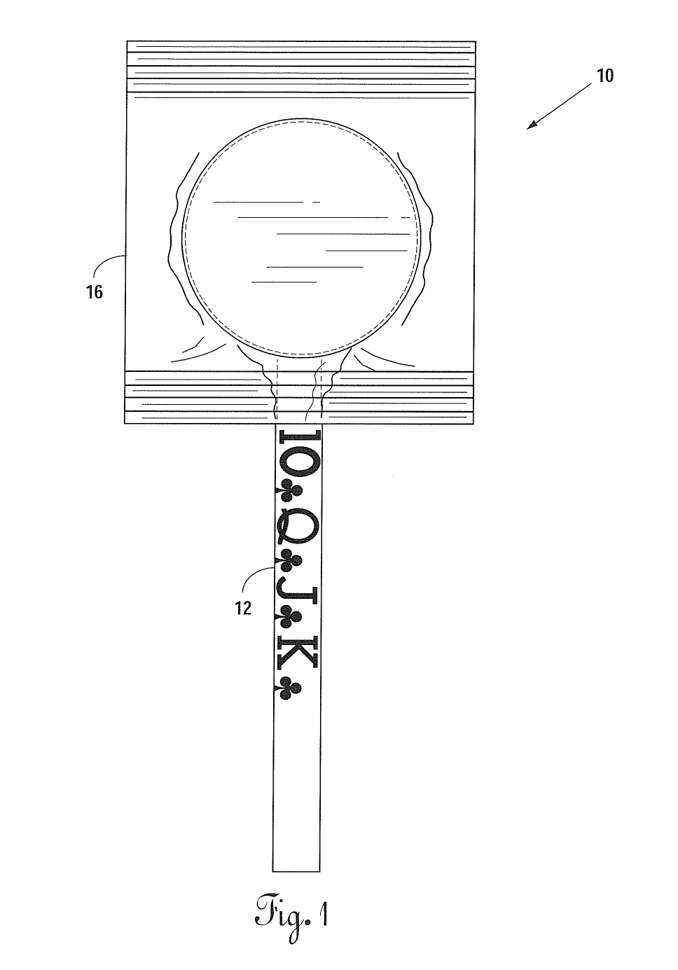

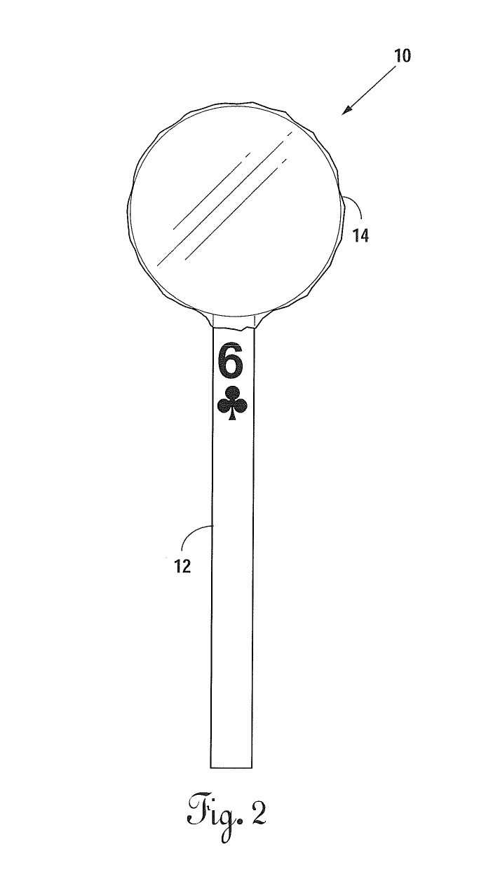

As shown in FIG. 1, the stick portion 12 of the lollipop 10 is imprinted with symbols designating certain playing cards. One or both sides of the candy portion 14 of the lollipop 10 are covered with a cover 16 having an opaque portion. When the cover 16 with the opaque portion is removed, such as shown in FIG. 2, the hidden symbol on the piece of candy 14 such as the Six of Clubs may be combined with the symbols on the stick 12 shown in FIG. 1. The combination of the set of symbols on the stick 12 and the set of symbols on the candy 14 may have a ranking according to the rules of a card game such as poker.

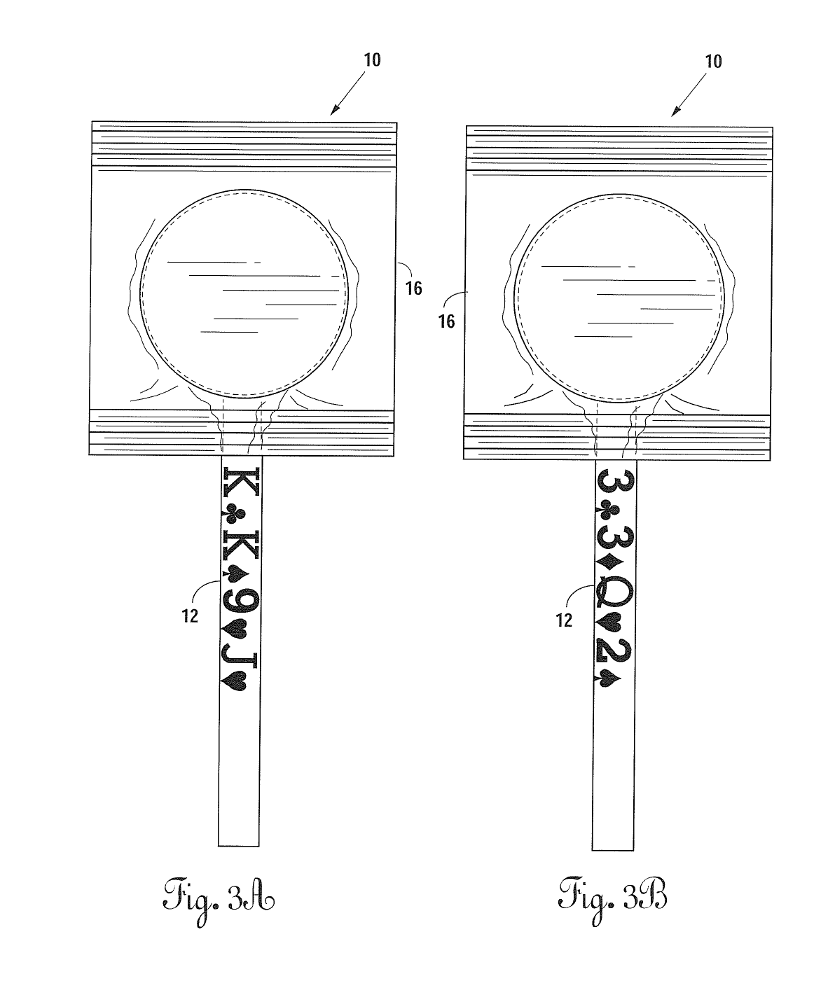

As shown in FIGS. 3A and 3B, two holders of the lollipops 10 may then compare their lollipops, to determine which holder has a poker hand with a higher ranking. Those of ordinary skill in the art will understand that instead of having four playing card symbols imprinted in the lollipop stick 12, less playing card symbols may be imprinted on the lollipop stick 12 and more playing card symbols may be imprinted on the candy 14. Alternatively, a symbol for a “joker” or a “wild card” playing card may be used if the rules of the card game allow for the use of such cards.

For example, as shown in FIG. 3A, player A may receive a lollipop 10 where the symbols for a King of Clubs (K [symbol] ), a King of Spades (K [symbol] ), a Nine of Hearts (9 ♡), and a Jack of Hearts (A ♡) appear on the lollipop stick 12. Player B may receive a lollipop where a Three of Clubs (3 [symbol] ), a Three of Diamonds (3 ♦), a Queen of Hearts (Q ♡), and a Two of Spades (2 [symbol] ) appear on the lollipop stick 12. Player A will realize that there is a possibility that that the covered candy piece 14 could include another Nine to make two pair, Kings and Nines, or the symbol for a third King may appear on the candy piece 14 to make three of a kind. Those of ordinary skill in the rankings of card combinations according to the rules of poker, or those just learning the game, will understand that three-of-a-kind has a higher ranking than two pair.

At the same time, player B may realize that there is a possibility that the covered candy piece 14 could include another card symbol of another suit bearing the number Three, thus making three-of-a-kind or a card symbol of another suit bearing the letter Q, thus making two pair.

As foregoing scenario described in FIG. 3 may cause the players to think in terms of what additional card is needed for a winning combination of cards, the present invention provides a system wherein the novice poker player may practice card reading skills and the beginning poker player may learn how to quickly assess a combination of playing cards according to the rankings in the game of poker. For more advanced poker players, the odds of receiving a card to complete the combination of either two-of-a-kind or three-of-a-kind according to the ranking in the rules of poker could be imprinted somewhere on the covered piece of candy 14, or on the inside of the cover 16.

Those of ordinary skill in the art will understand that the game between two players as shown in FIG. 3A and in FIG. 3B may be expanded to include additional players. Herein the numbers on the playing card symbols may be used to determine who has the higher ranking combination of cards if two players happen to have a three-of-a-kind combination. In addition, those of ordinary skill in the art will understand that the present invention may be used for other card games or any other game where rankings of combinations of sets of symbols determine the winner.

If there is the possibility of a tie between players, an additional indicia may be added to the piece of candy such as a gold or blue stripe or wreath, a silver or red stripe or wreath or a bronze or yellow colored strip or wreath. These additional indicia may be used to determine a winner in the case of a tie.

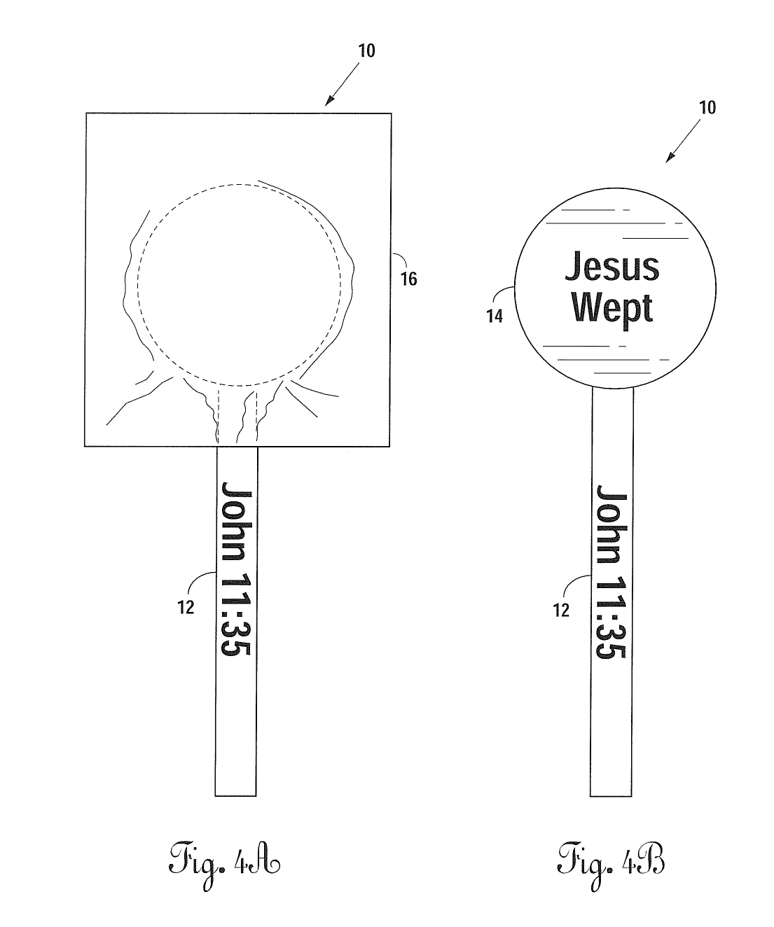

As shown in FIG. 4A and in FIG. 4B, the imprinting on the lollipop stick 12 may be a citation to a verse from the Holy Bible. Those of ordinary skill in the art will understand that the imprinting on the lollipop stick 12 may be the verse from the Holy Bible and imprinting on the candy may be citation for the imprinted verse on the lollipop stick 12 as shown in FIG. 4. For long verses, it is possible to imprint on more than one place on the lollipop stick 12 or on both sides of the candy 14 affixed to one end of the lollipop stick.

In yet another embodiment related to the embodiment shown in FIG. 4A and in FIG. 4B, one part of a verse from the Holy Bible may appear on the lollipop stick 12 and another part of the verse may appear on the candy 14 affixed to the end of the lollipop stick 12.

Those of ordinary skill in the art will realize that the invention may be used like flash cards to assist in other types of memory work such as learning the vocabulary or proper spelling of the words used in a language other than English, math facts or any other academic subject requiring memorization. If combinations of three sets of information are needed, a piece of candy may be affixed to both of the ends of the lollipop stick. Herein, the imprints on the candy pieces may include a right answer, a wrong answer, or two answers where one answer is more correct than the other answer.

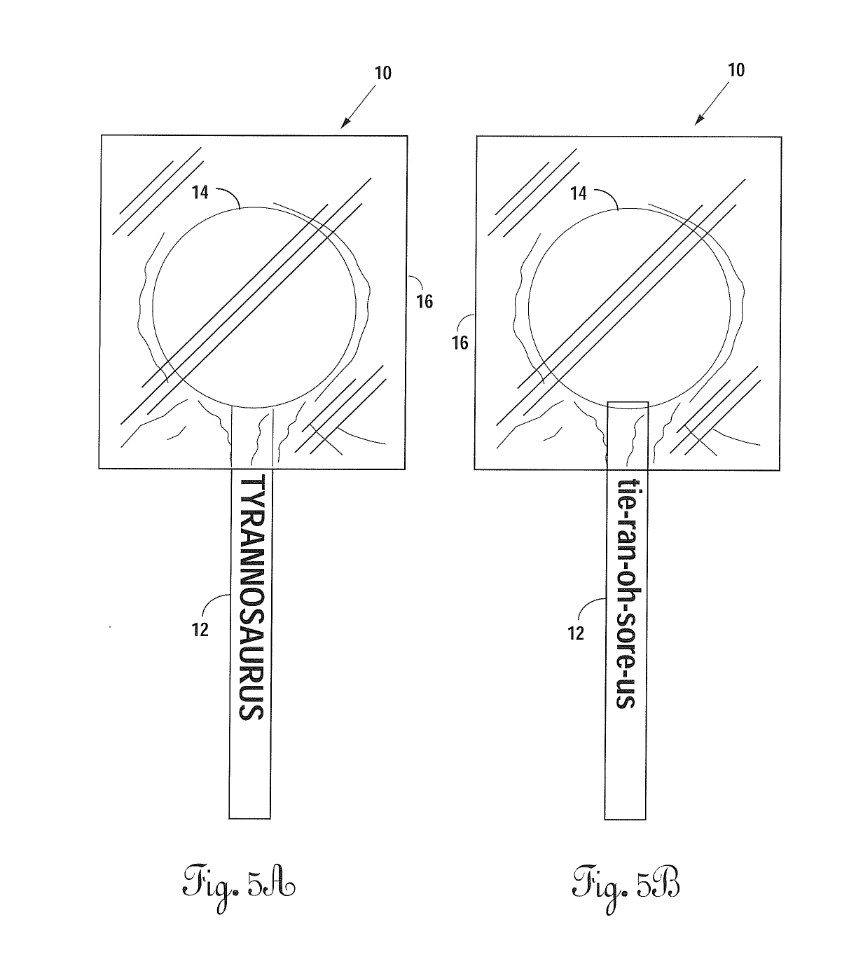

As shown in FIG. 5A and in FIG. 5B, in another exemplary embodiment, the words on the lollipop stick 12 may relate to the name of a dinosaur, the pronunciation of the name of the dinosaur, and a picture of the dinosaur on the piece of candy 14 affixed to the end of the lollipop stick. Herein, the covering 16 over the candy 14 may be clear so that anytime the lollipop 10 is picked up, the combination of the information on the stick portion 12 of the lollipop 10 will be associated with the information or picture imprinted on the candy portion 14 of the lollipop 10 to reinforce the recall or association between words and/or pictures. In addition, it is also possible to imprint additional information on the lollipop stick 12 such as the length of the dinosaur or how long ago it was alive. Those of ordinary skill in the art will understand that the stick portion 12 if the lollipop 10 can be masked with an opaque cover over a word or words related to the image appearing on the candy portion 14.

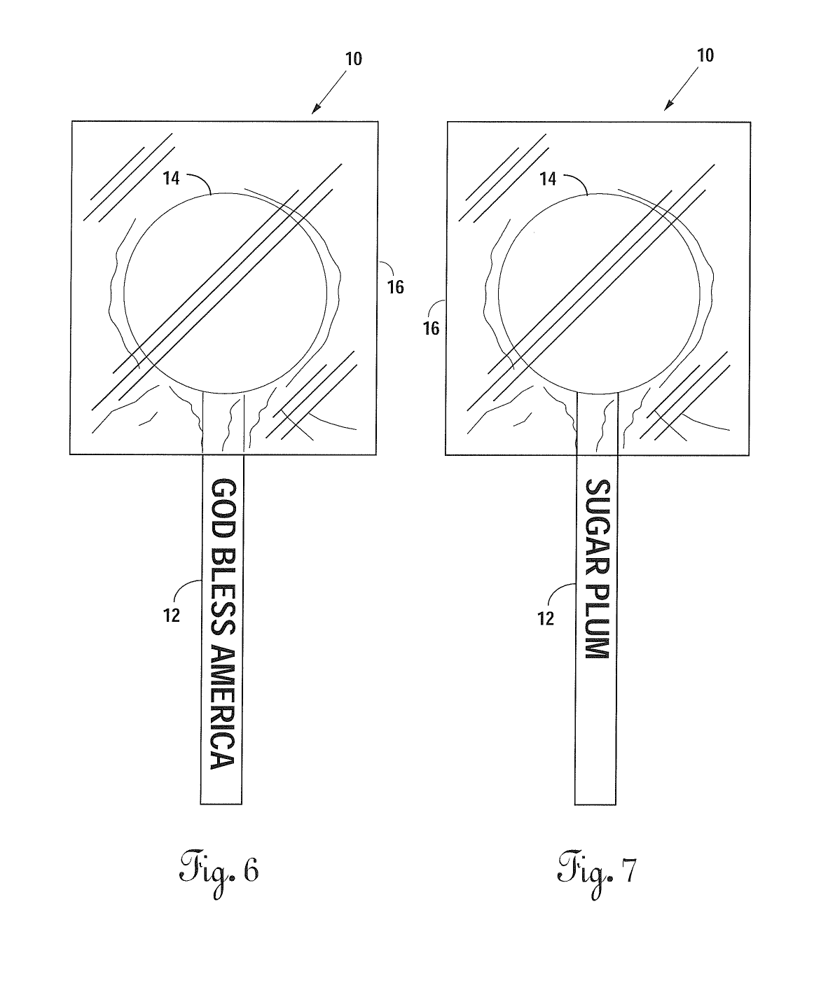

Shown in FIG. 6 is yet another embodiment of the disclosed invention 10 wherein the words on the lollipop stick 12 are related to what is imprinted on the candy portion 14 of the lollipop 10. Those of ordinary skill in the art will understand that the imprinted lollipop 10 of the present invention may be used to display information or a logo such as normally appears on a business card or to bring notice or to mark a special event such as a birth, a wedding, or an anniversary.

Shown in FIG. 7 is an embodiment similar to that shown in FIG. 6 but the word or words on the lollipop stick 12 bear little or no relation to the imprint on the candy 14 except for additional visual appeal. Herein a graphic logo may appear on the candy piece 14 and the product or service associated with the logo may appear on the lollipop stick 12.

In one method of manufacture, a laser engraver may be used to make rubber plates of the imprinted figure or words to be placed on the piece of candy 14 or on the lollipop stick 12 onto which the piece of candy is affixed. The rubber plate may be used to imprint the lollipop stick 12 with one or more colored markings. The rubber plate used to imprint the candy piece 14 enables the use of edible ink to form an imprint on the candy piece 14.

While the present invention has been described according to its preferred and alternate embodiments, those of ordinary skill in the art will understand that numerous other embodiments of the present invention may be embodied by the foregoing disclosure. Such other embodiment shall be included in the scope and meaning of the appended claims.

What is claimed is:

1. An imprinted lollipop for use in playing a card game, said imprinted lollipop comprising:
a stick imprinted with a first set of symbols representing playing cards;
a piece of candy affixed to one end of said stick;
an cover having an opaque portion placed over said piece of candy;
said piece of candy imprinted with a second set of symbols representing playing cards and being hidden by said opaque portion of said cover:
wherein the players of the game can remove said opaque cover and determine who has a winning combination of said first and second set of symbols representing playing cards according to the rules of game using playing cards.

2. The imprinted lollipop as defined in claim 1 wherein the rules of the game using playing cards come from the game of poker.

3. The imprinted lollipop as defined in claim 1 wherein said first set of symbols includes four symbols representing playing cards.

4. The imprinted lollipop as defined in claim 1 wherein said first set of symbols includes three symbols representing playing cards.

5. The imprinted lollipop as defined in claim 1 wherein said first set of symbols are colored according to the color of the suit of the playing card symbol.

6. The imprinted lollipop as defined in claim 1 wherein said second set of symbols are colored according to the color of the suit of the playing card symbol.

7. An imprinted lollipop for use as a memory aid, said imprinted lollipop comprising:
a stick imprinted with a first set of information;
a piece of candy affixed to one end of said stick;
a cover having an opaque portion over said piece of candy;
said piece of candy imprinted with a second set of information related to said first said information and being hidden by said opaque portion of said cover;
wherein the user of the lollipop can remove said cover having an opaque portion to determine said second set of information.

8. A method for making a lollipop for use in completing a set of information from two partial sets of information, said method comprising:
imprinting a lollipop stick with a first set of information;
imprinting a piece of candy with a second set of information, said second set of information enabling the completion of a set of information when combined with said first set of information;
affixing said piece of candy to said lollipop stick;
covering said imprint of on said piece of a candy with the opaque portion of a cover.
